(19) United States
(12) Patent Application Publication
(10) Pub. No.: US 2025/0252055 A1
(43) Pub. Date: Aug. 7, 2025

(54) CACHE MANAGEMENT IN A MULTI-PROCESSOR SYSTEM

(71) Applicant: Intel Corporation, Santa Clara, CA (US)

(72) Inventors: Duane E. GALBI, Wayland, MA (US); Christopher J. HUGHES, Santa Clara, CA (US); Andrew J. HERDRICH, Hillsboro, OR (US); Simon C. STEELY, JR., Hudson, NH (US); Chen DAN, Hadera (IL)

(21) Appl. No.: 19/188,395

(22) Filed: Apr. 24, 2025

(51) Int. Cl. G06F 12/0811; G06F 9/30; G06F 12/0831; G06F 12/0871

(52) U.S. Cl. CPC G06F 12/0811; G06F 9/3001; G06F 9/30043; G06F 12/0835; G06F 12/0871

(57) ABSTRACT

Examples described herein relate to a processor that includes a core and a cache, coupled to the core. In some examples, the core is to perform an instruction of a process to specify loads of data from a source to destination regions of caches of a group of target cores. In some examples, the destination regions includes multiple different cache regions and wherein cores of the group of target cores have at least one respective cache.

### BACKGROUND

Data centers provide vast processing, storage, and networking resources to users. For example, automobiles, smart phones, desktops, laptops, tablet computers, or internet of things (IoT) devices can leverage data centers to perform data analysis, data storage, or data retrieval. Data centers configure the processing, storage, and networking operations to manage power consumption while achieving performance goals.

Artificial Intelligence (AI) related computer workloads involve substantial numbers of data copying operations and data calculation operations. For instance, the Llama-3 405 billion parameter model contains 405 billion weight parameters. If the total data size of the weight parameters exceed a size of caches of general-purpose multiprocessors, the weight inputs to a linear algebra matrix are streamed from memory and intermediate matrix multiply inputs and the output are stored in the cache.

### BRIEF DESCRIPTION OF THE DRAWINGS

FIG. 1 depicts an example system.

FIG. 2 shows an example of computing a matrix multiply.

FIG. 3 depicts an example operation for a matrix multiply operation.

FIG. 4 depicts an example system.

FIG. 5 depicts an example process.

FIG. 6 depicts an example process.

FIG. 7 depicts an example system.

### DETAILED DESCRIPTION

Various examples provide a cache management technology that divides cache devices into multiple regions and a process specifies a cache region to read-from and/or write-to. The process can include an instruction, that when executed, allocates different or discontiguous regions of a cache to store data and allocates regions of the cache for management, debug, and other system on chip (SoC) tasks to not overwrite data that is processed. The cache regions can be targeted by loads and stores issued by a single core or loads and stores initiated by a per-core DMA engine or DMA engine for a group-of-cores. A circuitry that manages allocation of cache regions can allocate different or discontiguous cache regions based on the cache regions specified by the instruction.

At least in a general-purpose multiprocessor system on chip (SoC), various examples can manage caches for data processing using data multicast with synchronization. A virtual grouping of processor caches can be allocated for multicast of data to caches. An initiator (e.g., the processor or initiated by per-processor, or per-group of processors' direct memory access (DMA) engine) can issue a multicast load request with a command to return or pre-load data to cache regions of processor(s) in the virtual grouping. Accordingly, when other processors in the virtual grouping of processors attempt to access the data to process the data, the data can be available and stored in the associated caches.

For example, a process or thread can include multiple instructions. An instruction can specify a multicast group identifier (id) so that application code need not exactly specify target core(s) to communicate with and the same application code can execute on multiple cores or multiple different SOCs. The exact identification of target core(s) can be based on the multicast group-id and issuer core identifier so that target core(s) depend on an issuer core. A configuration for target core(s) for issuer core identifier a multicast group-ids can be stored in a cache or register and be utilized by a decoder to determine the target core(s). The instruction can specify cache regions so that data is loaded or stored to specific registers or particular regions of caches of target core(s), such as specific cache ways or levels of a cache. One or more cache regions can be allocated to a process or instruction.

Target processors can execute instructions to perform address-based synchronization for the multicasting operation to inform the initiator core that the data has been received associated with a particular source address. Address-based synchronization can provide synchronization among members of a multicast group, and can provide address-based synchronization between processors.

For example, where processors are coupled in a mesh communication networks, processors connected to a mesh row or mesh column can be associated with a multicast group-id or multicast virtual group identifier and the multicast virtual group identifier can have a group size. For example, for eight processors in a mesh row, the group size could be eight processors. Operations, such as matrix multiply or other operations, can be assigned to cores in a row of a mesh. Loading data to caches of processors in a mesh row grouping can provide both a reduction in power consumption and a reduction in amount of bandwidth utilized by the mesh network. Multicasting of data to cache regions allocated to processors in the virtual grouping can reduce the read bandwidth from the cache, reduce power consumed by the communication between the cache and the processors, and reduce bandwidth by inter-processor or inter-cache communication network.

To accelerate the completion of linear algebra matrix multiply operations, operations can be distributed among multiple processors in a general-purpose multiprocessor and data sharing scheduled among the caches of processors. For example, for performance of linear algebra calculations, an input vector is copied to caches of the processors and the weight parameters of the AI model may be split among processors for processing. As described herein, a process can issue load and store operations to target different cache regions for processing by different cores to avoid overwriting data utilized during linear algebra matrix multiply operations.

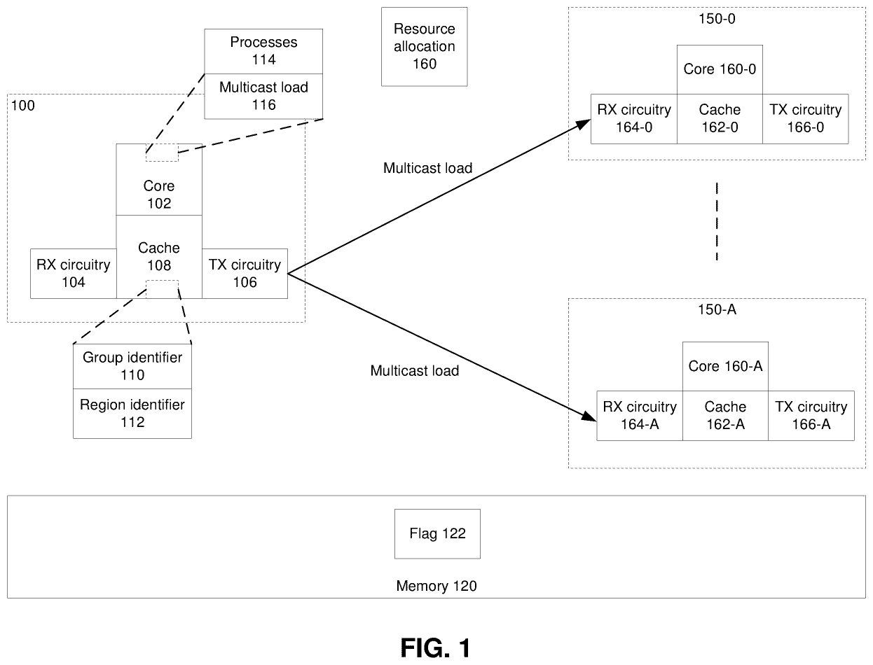

FIG. 1 depicts an example system. Processors 100 and 150-0 to 150-A, where A is an integer, can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry.

In some examples, as described herein, one or more of processors 100 and 150-0 to 150-A can be part of a mesh slice and mesh slices can be communicatively coupled by a mesh, as described herein.

Processors 100 and 150-0 to 150-A can include respective cores 102 and 160-0 to 160-A. Core 102 and/or 160-0 to 160-A can include an execution core or computational engine that is capable of executing instructions. Core 102 and/or 160-0 to 160-A can access to its own cache and read only memory (ROM), or multiple cores can share a cache or ROM. Core 102 and/or 160-0 to 160-A can be homogeneous (e.g., same processing capabilities) and/or heterogeneous devices (e.g., different processing capabilities). Core 102 and/or 160-0 to 160-A can be sold or designed by Intel®, Advanced RISC Machines (ARM)®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processors 100 and 150-0 to 150-A can include respective caches 108 and 162-0 to 162-A. Caches 108 and 162-0 to 162-A can include one or more of: a register, a level 1 (L1) cache, level 2 (L2) cache, level 3 (L3) cache, or last level cache (LLC). Registers can include model specific register (MSR), memory type range registers (MTRRs), shared memory region (including virtual memory), and/or register files. An MSR can include control registers used for program execution tracing, toggling of compute features, and/or performance monitoring. L1 cache can be utilized by a single core and can store the most frequently accessed data and instructions by the core. L2 cache be utilized by a single core and store both data and instructions. LLC can be shared among multiple cores and store data that has already been loaded into L2 caches, to be accessed by other cores. In some examples, cache 108 and 162-0 to 162-A can be organized in the form of: direct mapped, n-way set associative, fully associative, hash buckets, or others.

Cache 108 and 162-0 to 162-A can utilize system agent or uncore circuitry (not shown) that can include or more of a memory controller, a cache coherency manager, arithmetic logic units, floating point units, core or processor interconnects, Caching/Home Agent (CHA), interface circuitry (e.g., fabric, memory, device), bus or link controllers (e.g., Advanced Microcontroller Bus Architecture (AMBA) capabilities), direct memory access (DMA) engine, or others. DMA engine can be allocated per-core or per-small-group-of-cores.

A home agent (HA) can attempt to provide data coherency among cache devices and one or more memory devices. A caching agent (CA) can attempt to determine whether another core or processor has access to the same cache line and corresponding memory address to determine cache coherency. Where another core has access to the same cache line and corresponding memory address, the CA can provide data from its cache slice or obtain a copy of data from another core's cache.

Memory 120 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 120 can include static random access memory (SRAM) memory technology or memory technology consistent with high bandwidth memory (HBM), or double data rate (DDR), among others. Memory 120 can store data for processing by processors 100 and 150-0 to 150-A.

The following provides a description of an example multicast and synchronization operations. For example, core 102 can execute processes 114. Processes 114 can include one or more of: a processor-executable instruction, an application, process, thread, a virtual machine (VM), microVM, container, microservice, virtual function (VF), virtual device, or other virtualized execution environment. Processes 114 can perform one or more of: accumulation, computation, or arithmetic operations on received data, including: multiply-accumulate (MAC) operations (e.g., compute a product of two numbers and add the product to an accumulator), fused multiply-add (FMA), fused multiply-accumulate (FMAC), matrix multiplication, dot product, general matrix-matrix multiplication (GEMM) operations, summation of packet data with other packet data from other workers, multiplication, division, minimum, maximum, 16-bit number down conversion to 32-bit number, 32-bit number down conversion to 16-bit number, FP add, integer (INT) add, local minimum, local maximum, AND, OR, XOR, bitwise XOR, or other data computation operations related to AllReduce, ReduceScatter, or Allgather.

For example, core 102 can execute multicast load instruction 116, as part of processes 114 or separate from processes 114, to issue a multicast load of data to caches 162-0 to 162-A, which are associated with a multicast group identifier. Various examples can provide for execution of loads, prefetches, stores, and other memory accessing instructions that individually select which region of caches 162-0 to 162-A (e.g., register, L1, L2, or LLC) are to store the data. A region of a cache can include a cache way. A cache way can identify one or more cache lines. For example, regions of cache can be selected by a developer to prevent overwriting of data used in the same operation and to store data in a cache for a processor core that is to process the data to reduce delays in data availability in cache. Cache ways allow storing of data corresponding to multiple addresses that alias to the same cache set.

For example, in the case of a 15-way cache, there are 15 locations in the cache set for a given address and data for 15 different addresses that alias to the same cache set can be concurrently stored. For example, for 15 ways, cache group 1 can include ways 1-5, cache group 2 can include ways 6-8, cache group 3 can include ways 9-10 . . . group 7 represents an entire cache. A number of cache groups can be configured by a data center administrator, operating system (OS), firmware, or others.

Table 1 provides an example of cache management controls and multicast loads of instruction 116.

TABLE 1

| | For Loads | | | | |
|---|---|---|---|---|---|
| | and | For | | | |
| Attribute | Prefetches | Stores | Identifier | Examples | Comments |
| Cache Group | yes | yes | Cache | Load | A caching group is |
| | | | group | L2 = 3, | be specified for |
| | | | 3 bits | LLC = 3 | stores. If a caching |
| | | | specifying | | group is not |
| | | | 7 cache | | specified, the default |
| | | | groups | | group is used. |
| | | | and 1 no- | | |
| | | | cache | | |
| | | | group | | |
| Multiple Copy | yes | no | One bit | Load | A Store is a SC. |
| (MC) or Single | | | | L2 = 4, | |
| Copy (SC) | | | | MC | |
| Retain Count | yes | yes | One bit | Store | Applies to Loads |
| (RC) | | | | L2 = 4, SC, | and Stores that |
| | | | | RC | update an existing |
| | | | | | entry in the cache |

A format of instruction 116 could be as follows:
Load(source address, destination register, cache group identifier L2, cache group identifier LLC, MC/SC, RC)
or
Store(source address, destination register, cache group identifier L2, cache group identifier LLC, RC), where:
   source address can specify an address of data in memory or cache;
   destination register can identify a register in the issuing core;
   cache group identifier L2 can identify a target cache region in L2;
   cache group identifier LLC can identify a target cache region in LLC;
   MC/SC can indicate whether data is stored in multiple cache devices or a single cache device; and
   RC can indicate if data subjected to the load or store is to be subjected to a least recently used (LRU) aging counter, which can cause the data to be evicted from a cache for being least recently used.

A load pulls data from a location in memory into a register. Caches may already hold a copy of the data from memory, so the load may access a copy of the data in cache, rather than having to read from memory 120. For a load of data from memory 120 or from a cache, data can be stored into a register, and one or more levels of cache or some subset of those levels of cache.

A store can store data from a register into an address in memory 120 or a region of a cache.

For example, a load instruction can specify a cache way group (cache group) for both L2 and the LLC. For example, a load that specifies a cache group having L2=3 and LLC=3 can cause a check for the read data and if data is not stored in the L2, place the data in the L2 cache way group 3, but if the data is not found in both the L2 and the LLC, place the data in both the L2 and the LLC in their corresponding cache way-group or cache group of 3. However, if the data is not stored in the L2, but stored in the LLC, but not in the corresponding cache group 3, remove the data from the LLC and move the data to the L2 cache-way group 3 and to LLC cache-way group 3. In addition, if the data is found in another processor's L2 and not found in the requestor's L2 or the LLC, fetch the data from the other processors L2 and, as specified by the controls associated with the instruction, store the data in the LLC way-group 3 and the requestor's L2 way-group 3.

An SC can indicate a single copy of data is stored in cache and no other copy of the data is stored in another cache. MC can indicate data is stored as multiple copies in multiple caches. An SC load can include a read operation for ownership where the data is not stored in the LLC and is only stored in the requestor's L2. An MC load can include a load that returns a shared copy of data that could be stored in multiple L2 regions and the LLC, potentially in no L2 cache location and in the LLC, or in the LLC but not the L2.

Other cache hierarchy configurations, cache management controls, cache control options, and other extensions can be utilized.

Another example of semantics of instruction 116 can be as follows:
Load (issuing core identifier, source address, destination register, pattern ID)
or
Load (issuing core identifier, source address, destination register, pattern ID, group identifier), where:
   issuing core identifier can identify a core that executes a multicast instruction;
   source address can indicate an address of data in memory or cache;
   destination register can identify a register in the issuing core;
   pattern ID can indicate destination cores or mesh slices; and
   group identifier can indicate cache regions in which to store the data. Where a group identifier is not specified, the data can be copied to an entire cache.

Core 102 can provide a pattern ID, group identifier, and the issuing core identifier to TX circuitry 106 for interpretation based on group identifier 110, stored in LLC or registers. Group identifier 110 can define what cores are targets in a multicast group operation as a function of the identifier of the issuing core.

Group identifier 110 or class of service (CLOS) can identify an allocated region of caches 162-0 to 162-A to receive data. Group identifier 110 can be selected from at least: (1) L2 only, (2) LLC only, (3) L2 and the LLC, and (4) data is not to be stored at a cache level (e.g., L2 or LLC) but in memory 120. If the group identifier or CLOS specifies no caching, then do not store the data into caches 162-0 to 162-A, but store the data to memory 120. If no cache group is specified or a default value is used, the entirety of caches 162-0 to 162-A can be used to store data. For example, a 3-bit cache identifier field can specify one of seven cache way groups. An L2 cache group can be configured to have a corresponding LLC cache group so that when data is flushed from the L2 to the LLC, the LLC group associated with the L2 group can indicate the LLC is to store the data.

For example, TX circuitry 106 and/or resource allocation circuitry 160 can perform multicast instructions 116 to allocate cache regions per instruction and group indicator or CLOS. Resource allocation circuitry 160 can include at least Intel® Resource director technology (RDT) cache allocation technology (CAT). In some examples, the load or store instruction is not allowed to complete unless the issuing core is authorized to access the specified way-group on the specified destination core.

Various other examples of instruction 116 are described herein.

Receiver (RX) circuitry 164-0 to 164-A can receive cache line fills triggered by TX circuitry 106. However, a target core may not have requested the data, and the target core can be signaled by RX circuitry to initiate a read request to accept the fill and place the fill in regions of the in-core-caches specified by the group identifier. Various examples of synchronization can utilize Fuzzy load instructions to specify receipt of multi-casted data in flag 122, as described herein.

Various cache coherency protocols can be utilized for cache regions corresponding to particular group identifiers. Various cache coherency protocols can maintain cache coherency and can include snoop filters and directory-based protocols. Stores or loads can causes coherency operations where content of L1, L2, or LLC and memory space are coherent. Content of registers may not be coherent with memory space, so loads or stores to registers of cache 108 may not invoke coherency operations.

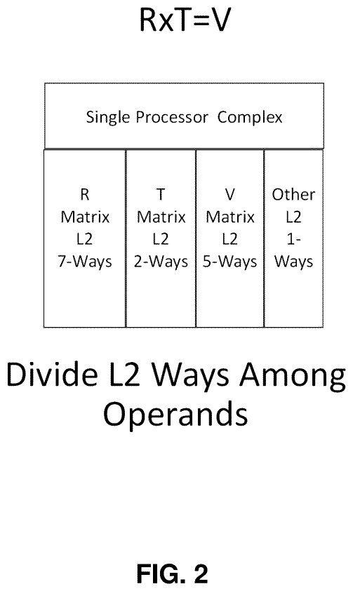

FIG. 2 shows an example of computing a matrix multiply R×T=V. When computing a matrix multiply operation, execution of an instruction can cause reservation of part of the L2 cache for one input matrix R, another part of the cache for the other input matrix T, and another part of the cache for the output matrix V. A group identifier or CLOS value for instructions to fetch R and T can cause store R and T into L2 cache regions that do not overlap. In this example, an instruction can specify a cache group identifier or C LOS for V that does not cause eviction of R and T or overwrite R and T.

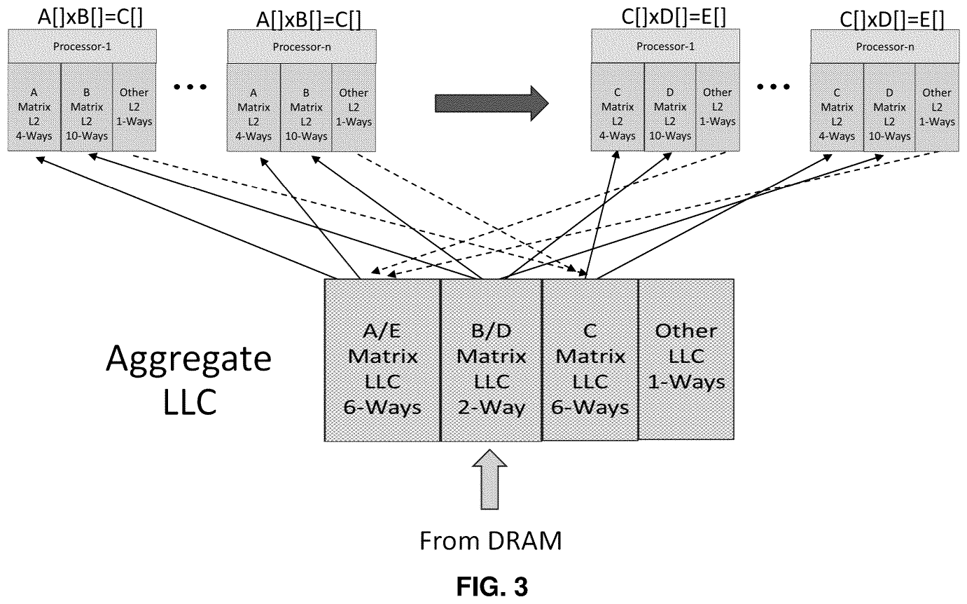

FIG. 3 depicts an example operation for a matrix multiply operation of A×B=C followed by a matrix multiply operation of C×D=E. The matrix multiplication can be distributed or sharded to be performed by multiple processors, so the matrix data read by the processor from the LLC for the second matrix multiplication is not the same part of the matrix data written by the processor during the first matrix multiplication. In this example, B and D can include constant weight matrices, and A and C can include results of a previous computation. When computing this sequence of matrix multiplies, data can be written directly to the LLC and read from both the L2 cache and the LLC. The LLC is depicted as a single structure, but it also can be implemented as a distributed structure. Using multicast instructions with cache control described herein, a developer can manage the passing of results from one matrix multiply to a subsequent matrix multiply. Using multicast instructions with cache control instructions described herein, the developer can dictate the placement of data in both the L2 and the LLC to increase AI processing performance by a general-purpose multiprocessor SOC.

For example, the following Load instructions can be performed as follows:
Load A to pattern of multiple cores to destination (which can be specified based on group identifier or not specify group identifier)
Load B to pattern of multiple cores to destination (which can be specified based on group identifier or not specify group identifier)

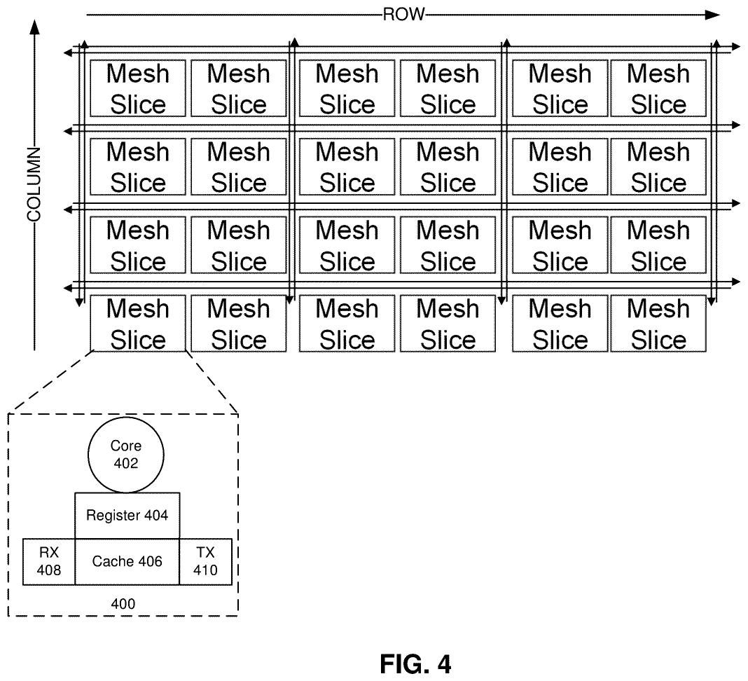

FIG. 4 depicts an example system. An on-chip two-dimensional mesh interconnect can interconnect multiple mesh slices. Mesh slices can be organized in rows and columns and the mesh interconnect can provide communication among processor slices. An example of a mesh slice is mesh slice 400. Mesh slice 400 can include a core 402, register 404, cache 406, receive (RX) circuitry 408, transmit (TX) circuitry 410, DMA circuitry, and other circuitry. For example, one or more mesh slices can include a cache agent (CA), home agent (HA), and snoop filter. Cores of multiple mesh slices can read and write from an LLC.

As described earlier, core 402 can execute one or more instruction that causes multicast of particular cache regions associated with particular cores. Execution of instruction Load, described earlier, can cause copying of data associated with the source address from memory or cache into the issuing core's register and copying the data from the register into regions caches, identified by the group identifier, of cores or mesh slices identified by the pattern ID and issuing core identifier. For example, core 402 can execute instruction Load to issue a multicast load to caches associated with a multicast group identifier (e.g., Pattern ID). Core 402 can provide pattern ID, group identifier, and the issuing core identifier to TX circuitry 410 for interpretation to determine target cores or mesh slices. In some examples, multiple processing cores in a mesh slice can share an L2 cache. For example, an LLC or MSRs of cache 406 can store a configuration that defines what cores are part of a multicast group specified by a pattern ID as a function of the issuing core. The core issuing the multicast operation may or may not be a target of the multicast operation. For instance, one core could issue a multicast operation targeting the cores on a specific mesh row but not receive data loaded to caches of other cores.

TX circuitry 410 can determine where a current copy of the requested data is located. The data, associated with a source address, can be stored in the slice cache (a cache-hit), in another core's cache, or in a memory device. In cases where the data is stored in another core's cache or in a memory device, TX circuitry 410 fetches the data is fetched and a cache line fill (e.g., a cache line of 64-bytes, but could be other sizes) is returned over the mesh to the requesting core and multicast. When core 402 issues a read request that cannot be serviced by its in-core cache 406 (e.g., L1 and/or L2), a hash of the address of the cache-line being requested to identify a mesh slice core that stores the data.

When different cores execute instruction Load, the target cores' TX circuitry can access LLC or MSRs to identify target cores or mesh slices based on the identifier of the different issuing cores.

Where cores of multiple slices execute processes that read the same data, a core or DMA circuitry can issue a load or write operation that indicates the data is to be returned to multiple slices. In this case, if the read operation cannot be serviced by the in-core caches, then the mesh slice can issue a multiple target load operation by specifying a virtual grouping of targets to receive the data (mesh id group or pattern ID). For mesh slices connected by a mesh-based interconnect, the mesh-id group can include and select: one or more cores on a mesh row, all rows and all cores, or a strict subset of the cores (e.g., less than all of the cores). The mesh-id-group could include both the issuing core and another predefined group of one or more cores. Various examples provide for execution of an instruction so cause data to be read once and stored to caches of slices associated with a pattern ID or mesh-id group in a case of mesh-connected cores to cause a cache line to be returned to the targets specified by the mesh-id group.

For example, execution of the instruction Load can cause at least: sending a data to each of the mesh slices specified by a mesh-id group; send a broadcast cache line fill to mesh slices in all rows and all mesh slice locations of the mesh along with the mesh-id group; send a multicast cache line fill to the mesh slices located on the same row; or access a cache and one data fill on the mesh can allocate data to caches of mesh slices in a single mesh row. For example, in a mesh that connects slices, the data can travel up a column to the row of interest and then be broadcast to mesh slices on the row.

Execution of the instruction can cause a multicast prefetch to be performed, where the data is not returned to a register but to a cache. The group identifier (e.g., way-group) specified on the multicast prefetch could determine where the data would be placed in the L2.

Multicast loads and prefetches could be performed by multiple cores in the multicast group so that a single core in the multicast group does not need to be responsible for issuing all the multicast loads/prefetches. The use of multicast prefetches, instead of multicast loads, could be used to spread multicast prefetch requests among cores of a multicast group. For example, address space can be divided (e.g., an interleaved or stepped fashion) so that different cores are responsible for multicast prefetching different parts of the address space.

For example, when a cache line fill arrives at a target of a mesh-ID group that has not requested the data, circuitry corresponding to RX circuitry 408 of the target core can initiate a read request to accept the fill and place the fill in the in-core-cache specified by the group identifier. In a system maintaining coherency ordering, the receiver core acknowledges receipt of data to synchronization control, and the synchronization would mark the load as complete when all of the multicast targets have responded as having received the data. For example, fuzzy load instruction, described herein, can be used for LLC synchronization.

In some cases, a multicast operation can attempt to push data to a cache region of a target cache that already has the data being pushed, or a demand load/prefetch can be issued and a multicast can push data to the L2 before the demand load/prefetch is finished. In such cases, if the data is already in the L2 or in the L2's in process queue, RX circuitry 408 can drop received multicast push data. Because multicast pushes are being dropped when an existing demand read/prefetch for the same data exists, the processing of the demand read/prefetch can be unaffected by multicast pushes.

### Indirect Store

Referring to FIG. 1, in some examples, a core can execute instruction 116 to perform an indirect store that sends data to a group of one or more target cores that did not request data. Example semantics of an instruction to perform an indirect store can be as follows.
Indirectstore (issuing core identifier, source register, destination address, pattern ID) or
Indirectstore (issuing core identifier, source register, destination address, pattern ID, group ID), where
   issuing core identifier can identify a core that executes a multicast instruction;
   source register can specify a register in issuing core;
   destination address can specify an address of data stored in memory or cache;
   pattern ID can indicate a group of one or more target core caches; and
   group ID can indicate data can be copied to one or more cache regions, no cache region, or all cache regions of a target cache.

Execution of instruction Indirectstore can cause a copy of data from a register of the issuing core into regions of caches of target cores identified by the group ID and target cores identified by the pattern ID.

To increase a processing chain to more than two cores, multiple paired group IDs can be used. For example, where four sets of paired cores perform a calculation, a first group ID pair could copy data from a register of a core of core-set1 to a cache region(s) of core-set2, a second pair group-id could copy data from a register of a core of core-set2 to a cache region(s) of core-set3, and a third pair group-id could copy data from a register of a core of core-set3 to a cache region(s) of core-set4.

Synchronizing after Multicast

Utilization of different cache way-groups allow data to be fetched into one cache way-group while data is read out of another way-group. Various examples provide for synchronization before switching between these cache ways-groups and can assure that the multicast loads have completed at the target. A fuzzy-load instruction, described herein, can cause a target core to wait, on a per address basis, for the multicast to finish at the target cores in order to perform synchronization between the multicast load and the subsequent loads at multicast targets. For example, the core that initiated the multicast load can issue multicast loads indicating the appropriate multicast group and the appropriate L2 cache way-group for data associated with an address, whereas targets other than the issuer of the multicast load can issue a fuzzy-load for data from the same address. Combining multicasting, group identifier (e.g., way-grouping), and fuzzy-load, a developer can introduce an address-based synchronization semaphore spanning a multicast group.

An example format of a fuzzy-load instruction can be as follows:
Fuzzyload(source address, destination register, wait (Y/N), time out, peek-and-delay) or
Fuzzyload(source address, destination register, wait (Y/N), time out, peek-and-delay, group identifier), where:
   source address can specify an address of data stored in memory or cache of the issuing core;
   destination register can specify a destination register for the data;
   wait (Y/N) can specify whether the target core is to wait for receipt of the data associated with the source address;
   time out is to indicate an amount of time for the target core to wait for receipt of the data at the destination register;
   peek-and-delay can indicate whether to return a fixed value (e.g., zero) to a particular memory address on a read timeout; and
   group identifier can indicate data can be copied to one or more cache regions, no cache region, or all cache regions of a target cache.

For example, when the wait flag is set to Y, the fuzzy-load could read from a specific way-group or register and if data associated with the source address does not exist in this way-group or register, the target core could wait for the data to be present. After a certain number of cycles specified in time out, the load could time-out. This time-out delay value could be specified in a register and could be on the order of a few hundred or few thousand clock cycles, or other values. An indication of timeout can be indicated by a peek-and-delay flag (e.g., flag 122 of FIG. 1). A target core can check if the data is stored in the register or cache without causing a read to be issued beyond the cache. After a timeout occurs, the fuzzy load can be automatically re-issued without the wait flag set.

Initially a core, or other circuitry not in the multicast group, can store a non-zero value of peek-and-delay flag to a given address (e.g., flag 122 of FIG. 1) to signify non-completion of loading of the data into all of the multicast target caches. If the multicast targets execute fuzzy-loads with the peek-and-delay flag, targets can wait on a return value of zero while waiting for the data to arrive in the register or cache. Storing of a zero value at the address can signify completion of multicast loads to an address at all of the multicast targets and can be used as a synchronization event to identify the same data is available for processing by the multicast target cores.

A combination of indirect stores from the core generating the data to the way group of the target core and a fuzzy-load being issued on the target core allows for address-based synchronization of data receipt.

For example, multicast with cache way identification and fuzzy-load can be used as a synchronization event for linear algebra matrix AI processing for synchronization of the output from one operation to the use of this output in a subsequent linear algebra matrix operation. In a multi-core implementation, synchronization occurs from the write of one core to the read of this data by one or more other cores. When multiple cores are working together on the linear algebra matrix operation, the synchronization can utilize fuzzy-load operations.

In linear algebra vector-matrix calculations, one core can calculate half the vector sum and to pass half of the vector sum to another core to calculate the final half of the vector product and the final overall vector product sum. For example, during a linear algebra vector multiplication, cache operations of multiple cores can be synchronized in an address-based manner, described herein.

Note that aspects of an instruction (e.g., Load, Store, Indirect Load, Fuzzy load) can be combined with other instructions.

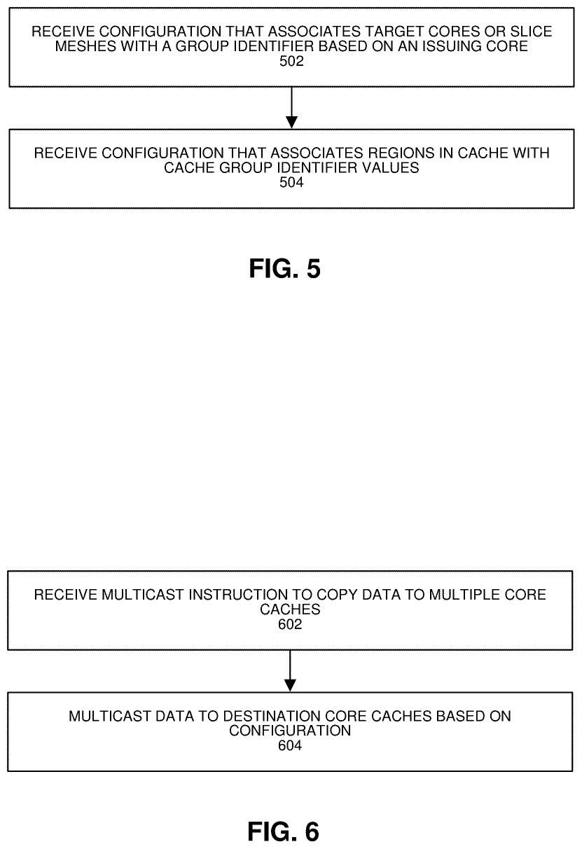

FIG. 5 depicts an example process. The process can be performed by an orchestrator, operating system, or other software to configure a platform with multiple connected cores and caches. At 502, the platform can be configured to associate a group of one or more target core caches based on initiating core with a pattern ID of target cores. For example, the following table depicts an example association of pattern IDs with one or more target core caches.

TABLE 2

| Pattern ID | Initiating core ID | Target core(s) |
|---|---|---|
| 0 | 1 | 1, 2, 3, 4 |
| 0 | 2 | 5, 6, 7, 8 |
| 0 | 3 | 9, 10 |
| 1 | 1 | 11, 12, 13, 14, 15, 16, 17, 18 |

At 504, the platform can be configured to associate multiple different cache regions with a cache group identifier. For example, the following table depicts an example of association of cache group identifier values and regions in register, L1 cache, L2, cache, or LLC.

TABLE 3

| Cache group | | | | |
|---|---|---|---|---|
| identifier value | Register | L1 Cache | L2 Cache | LLC |
| 0 | 0, 1 | N/A | N/A | N/A |
| 1 | Not | Cache ways 0-3 | Cache | N/A |
| | applicable | | ways 4-6 | |
| | (N/A) | | | |
| 2 | Any | N/A | N/A | Cache |
| | register | | | ways 1-3 |
| 3 | 0 | Cache ways 4-7 | N/A | |
| . . . | | | | |
| 7 | N/A | N/A | N/A | N/A |

For example, a cache group identifier value of 0 can indicate data is to be stored in registers 0 and 1 but not in another cache region. For example, a cache group identifier value of 1 can indicate data is to be stored in cache ways 0-3 of L1 cache but not registers or in another cache region. For example, a cache group identifier value of 7 can correspond to no use of the cache.

For example, a register or memory region can store the configurations and the pattern ID and cache group identifier configurations to be applied by execution of multicast instructions (e.g., Load or fuzzy-load), described herein.

FIG. 6 depicts an example process. The process can be performed by a processor core, DMA engine, cache device, circuitry, or other examples described herein. At 602, based on execution of a multicast load instruction, circuitry can read configurations to identify target core caches or registers. For example, the multicast load instruction can include a Load, Store, Indirect store, fuzzy-load, or combinations of instructions described herein.

At 604, the data can be copied to core caches or registers based on a stored configuration that identifies target cores based on an issuer core identifier and registers or cache way group regions. For example, execution of the multicast load instruction on different issue cores can cause loading of data to different core caches or registers as the target core caches or registers can depend on the issuer core.

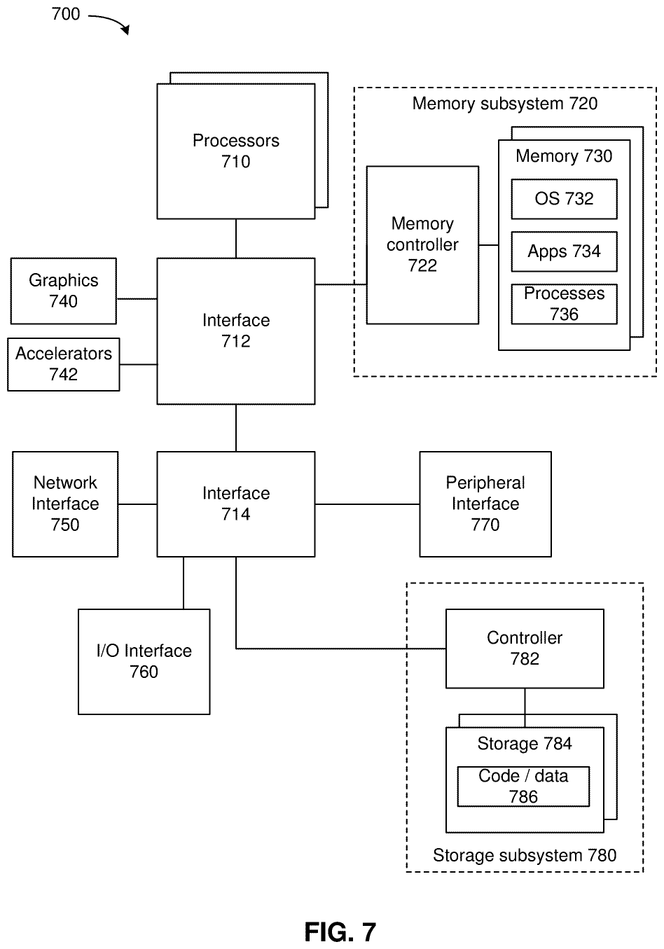

FIG. 7 depicts a system. In some examples, cores of processor 710, graphics 740, accelerators 742, network interface 750, or other circuitry can be configured to perform multicast load instructions, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 710 can include multiple processors and multiple processors can be embodied as processor sockets. Processor 710 can include E-cores or P-cores, described herein.

In one example, system 700 includes interface 712 coupled to processor 710, which can represent a higher speed interface or a high throughput interface for system components, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or M L model. Multiple neural networks, processor cores, or graphics processing units can be made available for use by AI or M L models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can bean integrated memory controller, integrated onto a circuit with processor 710.

Applications 734 and/or processes 736 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, workstations, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDM A over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, N V L ink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes a processor comprising: a core and a cache, coupled to the core, wherein: the core is to perform an instruction of a process to specify loads of data from a source to destination regions of caches of a group of target cores, wherein the destination regions comprise multiple different cache regions and wherein cores of the group of target cores have at least one respective cache.

Example 2 includes one or more examples, and includes a direct memory access (DMA) circuitry coupled to the core, wherein the DMA circuitry is to initiate the loads of data from the source to destination regions of caches of the group of target cores.

Example 3 includes one or more examples, wherein the source comprises one or more of: a level 1 (L1) cache, a level 2 (L2) cache, a level 3 (L3) cache, last level cache (LLC), or memory.

Example 4 includes one or more examples, wherein: the caches of the group of target cores comprise one or more of: a level 1 (L1) cache, a level 2 (L2) cache, a level 3 (L3) cache, or last level cache (LLC) and the multiple different cache regions comprise different cache ways.

Example 5 includes one or more examples, wherein: the instruction identifies: the core, a target core group, and an identifier indicating the destination regions of caches or no cache region.

Example 6 includes one or more examples, wherein: the target core group identifies the group of target cores based on the identifier of the core.

Example 7 includes one or more examples, wherein: at least one core of the group of target cores is to execute a second instruction that causes indicating whether loading of the data into the destination regions occurred.

Example 8 includes one or more examples, wherein: the data comprises an output of a first matrix multiply operation and wherein the performing the instruction causes copying of the output of the first matrix multiply operation to the destination regions of caches of the group of target cores.

Example 9 includes one or more examples, and includes a mesh interconnect, wherein the group of target cores are connected in a row or column of the mesh interconnect.

Example 10 includes one or more examples, and includes at least one non-transitory computer-readable medium comprising instructions stored thereon, that if executed by one or more processors, cause the one or more processors to: perform an instruction of a process to specify loads of data from a source to destination regions of caches of a group of target cores, wherein the destination regions comprise multiple different cache regions.

Example 11 includes one or more examples, wherein: the source comprises one or more of: a level 1 (L1) cache, a level 2 (L2) cache, a level 3 (L3) cache, last level cache (LLC), or memory; the caches of the group of target cores comprise one or more of: a level 1 (L1) cache, a level 2 (L2) cache, a level 3 (L3) cache, or last level cache (LLC); and the multiple different cache regions comprise different cache ways.

Example 12 includes one or more examples, wherein: the instruction identifies: the core, a target core group, and an identifier indicating the destination regions of caches or no cache region and the target core group identifies the group of target cores based on the identifier of the core.

Example 13 includes one or more examples, wherein based on the identifier indicating no cache region, performing the instruction causes storage of the data to memory.

Example 14 includes one or more examples, and includes instructions stored thereon, that if executed by one or more processors, cause the one or more processors to: cause the group of target cores to execute a second instruction that causes indicating whether loading of the data into the destination regions occurred.

Example 15 includes one or more examples, and includes an apparatus that includes: an interface and circuitry, coupled to the interface, the circuitry to: allocate multiple cache regions for an instruction, in response to a request from the instruction that specifies at least one of the multiple cache regions, allocate the at least one of the multiple cache regions to a process, wherein the process comprises the instruction, and the instruction is to specify loads of data from a source to the at least one of the multiple cache regions.

Example 16 includes one or more examples, wherein: the source comprises one or more of: a level 1 (L1) cache, a level 2 (L2) cache, a level 3 (L3) cache, last level cache (LLC), or memory; the cache regions comprise regions of one or more of: a level 1 (L1) cache, a level 2 (L2) cache, a level 3 (L3) cache, or last level cache (LLC); and the cache regions comprise different cache ways.

Example 17 includes one or more examples, wherein: the request identifies: an initiating core, a target core group, and an identifier indicating cache regions to allocate or no cache region.

Example 18 includes one or more examples, wherein: the target core group identifies the respective cores based on the identifier of the initiating core.

Example 19 includes one or more examples, wherein: based on the identifier indicating no cache region, the circuitry is to allocate no cache region to receive the data from the source.

Example 20 includes one or more examples, and includes a mesh interconnect, cache devices, and cores, wherein the cores and the cache devices are connected in a row or column of the mesh interconnect and wherein the multiple cache regions are allocated in the cache devices.

1. An apparatus comprising:
a processor comprising:
a core and
a cache, coupled to the core, wherein:
the core is to perform an instruction of a process to specify loads of data from a source to destination regions of caches of a group of target cores, wherein the destination regions comprise multiple different cache regions and wherein cores of the group of target cores have at least one respective cache.

2. The apparatus of claim 1, comprising:
a direct memory access (DMA) circuitry coupled to the core, wherein the DMA circuitry is to initiate the loads of data from the source to destination regions of caches of the group of target cores.

3. The apparatus of claim 1, wherein the source comprises one or more of: a level 1 (L1) cache, a level 2 (L2) cache, a level 3 (L3) cache, last level cache (LLC), or memory.

4. The apparatus of claim 1, wherein:
the caches of the group of target cores comprise one or more of: a level 1 (L1) cache, a level 2 (L2) cache, a level 3 (L3) cache, or last level cache (LLC) and
the multiple different cache regions comprise different cache ways.

5. The apparatus of claim 1, wherein:
the instruction identifies: the core, a target core group, and an identifier indicating the destination regions of caches or no cache region.

6. The apparatus of claim 5, wherein the target core group identifies the group of target cores based on the identifier of the core.

7. The apparatus of claim 1, wherein:
at least one core of the group of target cores is to execute a second instruction that causes indicating whether loading of the data into the destination regions occurred.

8. The apparatus of claim 1, wherein the data comprises an output of a first matrix multiply operation and wherein the performing the instruction causes copying of the output of the first matrix multiply operation to the destination regions of caches of the group of target cores.

9. The apparatus of claim 1, comprising:
a mesh interconnect, wherein the group of target cores are connected in a row or column of the mesh interconnect.

10. At least one non-transitory computer-readable medium comprising instructions stored thereon, that if executed by one or more processors, cause the one or more processors to:
perform an instruction of a process to specify loads of data from a source to destination regions of caches of a group of target cores, wherein the destination regions comprise multiple different cache regions.

11. The non-transitory computer-readable medium of claim 10, wherein:
the source comprises one or more of: a level 1 (L1) cache, a level 2 (L2) cache, a level 3 (L3) cache, last level cache (LLC), or memory;
the caches of the group of target cores comprise one or more of: a level 1 (L1) cache, a level 2 (L2) cache, a level 3 (L3) cache, or last level cache (LLC); and
the multiple different cache regions comprise different cache ways.

12. The non-transitory computer-readable medium of claim 10, wherein:
the instruction identifies: the core, a target core group, and an identifier indicating the destination regions of caches or no cache region and
the target core group identifies the group of target cores based on the identifier of the core.

13. The non-transitory computer-readable medium of claim 12, wherein based on the identifier indicating no cache region, performing the instruction causes storage of the data to memory.

14. The non-transitory computer-readable medium of claim 10, comprising instructions stored thereon, that if executed by one or more processors, cause the one or more processors to:
cause the group of target cores to execute a second instruction that causes indicating whether loading of the data into the destination regions occurred.

15. An apparatus comprising:
an interface and
circuitry, coupled to the interface, the circuitry to:
allocate multiple cache regions for an instruction,
in response to a request from the instruction that specifies at least one of the multiple cache regions, allocate the at least one of the multiple cache regions to a process, wherein the process comprises the instruction, and
the instruction is to specify loads of data from a source to the at least one of the multiple cache regions.

16. The apparatus of claim 15, wherein:
the source comprises one or more of: a level 1 (L1) cache, a level 2 (L2) cache, a level 3 (L3) cache, last level cache (LLC), or memory;
the cache regions comprise regions of one or more of: a level 1 (L1) cache, a level 2 (L2) cache, a level 3 (L3) cache, or last level cache (LLC); and
the cache regions comprise different cache ways.

17. The apparatus of claim 15, wherein:
the request identifies: an initiating core, a target core group, and an identifier indicating cache regions to allocate or no cache region.

18. The apparatus of claim 17, wherein:
the target core group identifies the respective cores based on the identifier of the initiating core.

19. The apparatus of claim 17, wherein:
based on the identifier indicating no cache region, the circuitry is to allocate no cache region to receive the data from the source.

20. The apparatus of claim 15, comprising a mesh interconnect, cache devices, and cores, wherein the cores and the cache devices are connected in a row or column of the mesh interconnect and wherein the multiple cache regions are allocated in the cache devices.
